(19) United States
(12) Patent Application Publication
(10) Pub. No.: US 2023/0269323 A1
(43) Pub. Date: Aug. 24, 2023

(54) METHOD OF MUTING HOLD MUSIC FOR A CELLULAR DEVICE

(71) Applicant: Fernando Fontanez, Washington, DC (US)

(72) Inventor: Fernando Fontanez, Washington, DC (US)

(21) Appl. No.: 17/652,386

(22) Filed: Feb. 24, 2022

(51) Int. Cl. H04M 1/72463; H04M 1/725

(52) U.S. Cl. CPC H04M 1/72463; H04M 1/725

(57) ABSTRACT

A method for muting a cellular device by an activator button being pressed on a cellular device. A signal is sent to the cellular device upon pressing the activator which in turn mutes audio being received by the device. The device is unmuted when the user is taken off hold.

### BACKGROUND OF THE INVENTION

The present invention relates to cellular devices and, more particularly, to a method of muting hold music therefor.

It is common to be placed on hold when connecting to a call. While waiting on hold on a phone, many people become annoyed or aggravated with the hold music or the messages that play. It is not uncommon to wait on hold for dozens of minutes, even hours.

Presently, all that can be done is bear with it and listen to the music and messages. A user may put the phone down and revisit the phone later. However, that risks being taken off hold while the user is not present. The user will then be hung up on and have to call back, restarting the process.

As can be seen, there is a need for an invention which mutes the music and messages while on hold and unmutes the device when taken off hold.

### SUMMARY OF THE INVENTION

In one aspect of the present invention, a method for muting a cellular device comprises an activator being pressed on a cellular device, sending a signal to the cellular device, muting audio being received by the cellular device, monitoring the audio, and unmuting the audio when a user is taken off hold.

These and other features, aspects and advantages of the present invention will become better understood with reference to the following drawings, description, and claims.

### BRIEF DESCRIPTION OF THE DRAWINGS

FIG. 1 is a schematic view of a cell phone for use with a method of muting hold music according to an embodiment of the present invention, with a button not activated;

FIG. 2 is a schematic view thereof with the button activated; and

FIG. 3 is a flow chart of a method of muting hold music according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a method of muting hold music and recordings received by a cellular device.

A button on the present invention enables a user to mute a phone call when the user is waiting on hold. The button may mute music or messages playing while the user is on hold. The muting of the device may last for a duration of the hold. The button may then unmute the phone call when the user is taken off hold.

The present invention may comprise a mechanical mute button integrated with an electrical circuit board/processor of a cellular device. This mute button may be integrated into a cellular device by a cell phone manufacturer. The mute button may be on a side of the cellular device. The button may be a knob, a switch, or a protrusion. The embodiment of the button may not be limited by the present invention. The mute button may be integrated into a circuit board or processor of the cellular device. A function of the button may be activated by pressing it.

The circuit board or processor may unmute the cellular device when it senses that a user is removed from hold. The device may sense a break in the hold music or a pattern of the hold music indicating the user is taken off hold. Alternatively, the device may sense a human voice indicating the user is off hold.

In some embodiments of the present invention, the cellular device may cellular device have a hold-muting activator and a processor electronically communicating therewith. A signal may be sent to the cellular device upon a pressing of the activator. Incoming audio received by the cellular device may be muted for a duration of the user being placed on hold. The incoming audio may be monitored for an indication the user is taken off of hold or that the hold period has ended. The incoming audio may then be unmuted.

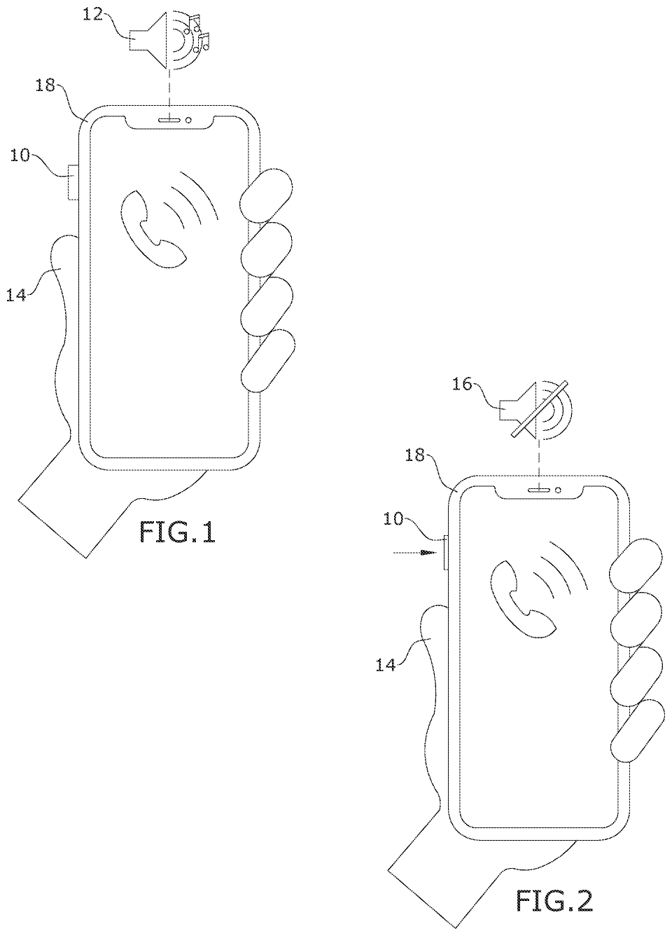

Referring to Figures, FIGS. 1 and 2 show a schematic view according to an embodiment of the present invention. A button 10 is a part of a cellular device 18. A user 14 may activate the button 10 by pushing it. As shown in FIG. 1, before the button 10 is pressed, sound 12 is emitted from the cellular device 18. As shown in FIG. 2, when the button 10 is pressed, sound 12 is no longer emitted from the cellular device 18 as indicated by the mute signal 16.

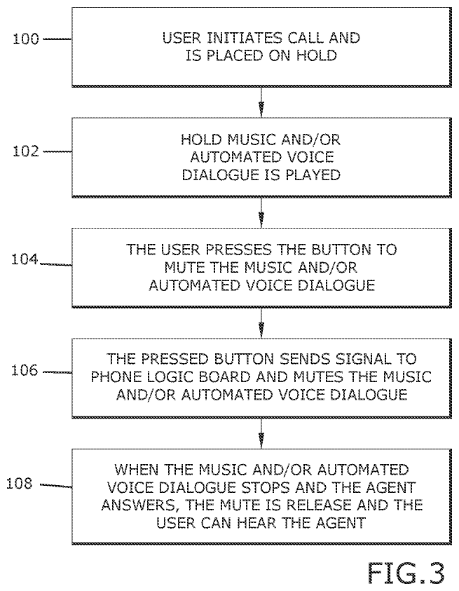

FIG. 3 details steps of the present invention. A user initiates a call and is placed on hold 100. Conversely, the user may not have initiated the call but be placed on hold by another party. Hold music or hold dialogue is played through the cellular device. 102. The user presses the button to mute the hold music or hold dialogue 104. The pressed button sends a signal to the circuit board or processor (circuitry). In turn, the cellular device mutes the hold music or hold dialogue 106. When the user is taken off of the hold music or the hold dialogue, the mute is released, and the user can hear whoever is on the line 108.

It should be understood, of course, that the foregoing relates to exemplary embodiments of the invention and that modifications may be made without departing from the spirit and scope of the invention as set forth in the following claims.

What is claimed is:

1. A method for muting a cellular device comprising:
providing a cellular device having a hold-muting activator and a processor electronically communicating therewith
sending a signal to the cellular device upon a pressing of the activator;
muting incoming audio received by the cellular device for a duration of a user being on hold;
monitoring the incoming audio for an indication that a hold period has ended; and
unmuting incoming audio received by the cellular device when the hold period has ended.
